(19) United States
(12) Patent Application Publication
(10) Pub. No.: US 2011/0179060 A1
(43) Pub. Date: Jul. 21, 2011

(54) Automatic Context Discovery

(75) Inventors: Venkat Pradeep Chilakamarri, Redmond, WA (US); Nicholas Caldwell, Bellevue, WA (US); Saliha Azzam, Redmond, WA (US); Benjamin Edward Childs, Seattle, WA (US); Arun Chitrapu, Seattle, WA (US); Steven Dimmick, Mill Creek, WA (US); Bernhard SJ Kohlmeier, Woodinville, WA (US); Shiun-Zu Kuo, Bothell, WA (US); Jonathan C. Ludwig, Kirkland, WA (US); Kimberly Manis, Seattle, WA (US); Courtney Anne O'Keefe, Bellevue, WA (US); Diego Perez Del Carpio, Redmond, WA (US); Tu Huy Phan, Redmond, WA (US); Kevin Powell, Kirkland, WA (US); Jignesh Shah, Bellevue, WA (US); Ashish Sharma, Bellevue, WA (US); Paulus Willem ter Horst, Bothell, WA (US); Mukta Pramod Walvekar, Sammamish, WA (US)

(73) Assignee: Microsoft Corporation, Redmond, WA (US)

(21) Appl. No.: 12/818,546

(22) Filed: Jun. 18, 2010

Related U.S. Application Data
(60) Provisional application No. 61/296,343, filed on Jan. 19, 2010.

(51) Int. Cl. G06F 17/30

(52) U.S. Cl. 707/769; 707/E17.014

(57) ABSTRACT

An automatic discovery of content to add to a data store for a project is disclosed. A data item may be parsed for data features that are contextually relevant to a given project or task. Discovered interesting data may be extracted and mapped to various search mechanisms. A search may be built and applied to various data sources to discover data items based on the contextually relevant data features. Search results from various search mechanisms may be displayed in a single user interface and may be presented to a user.

### CROSS REFERENCE TO RELATED APPLICATIONS

This application claims benefit under 35 U.S.C. §119(e) of U.S. Provisional Patent application Ser. No. 61/296,343 entitled “Aggregating and Presenting Associated Information (Huddle)” and filed on Jan. 19, 2010, the entirety of which is incorporated by reference herein.

### BACKGROUND

Currently, when managing information, users oftentimes handle specific units of content, or data items (e.g., email, documents, etc.), in isolation. Typically, a given document may be more useful to a user if it is in context of other related content, especially if the document is a data item of a particular project. For example, consider a user who is working on a project about computers, and he/she has several documents about various components of a computer, as well as several emails from other project members about various subjects relating to a computer. If the user is reading or editing one of the documents about a computer component, it would be most advantageous to the user to have knowledge of the other documents and emails that are contextually related to the particular document that he/she is using.

It is with respect to these and other considerations the present invention has been made.

### SUMMARY

Embodiments of the present invention solve the above and other problems by providing for automatically discovering a context of a data item, and for bringing together sources of information that may be relevant to the given data item. A data item may be parsed for interesting data or data item features, information may be extracted, and a search may be built and applied to various other data sources based on the context discovered for the parsed data item.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The accompanying drawings, which are incorporated in and constitute a part of this disclosure, illustrate various embodiments of the present invention. In the drawings:

FIG. 1A is a block diagram of an operating environment of a project data aggregation and management (PDAM) application.

FIG. 1B is a block diagram of an operating environment for providing automatic context discovery.

FIG. 2 is an illustration of an example PDAM user interface showing extracted data.

FIG. 3 is a flow chart of a method for providing automatic context discovery.

FIG. 4 is a block diagram of a system including a computing device with which embodiments of the invention may be practiced.

### DETAILED DESCRIPTION

Embodiments of the present invention are directed to automatically discovering context of a data item, and to bringing together sources of information that may be contextually relevant to the given data item. A data item may be parsed for interesting data or features, such as keywords, questions, answers, terms, links, clip art, authors, senders, receivers, dates, times, as well as, other content from electronic documents, electronic mail, calendar items, contacts items, tasks items, social network communications and the like. Discovered interesting data may be extracted and mapped to a plurality of search mechanisms. A search may be applied to various data sources by the plurality of search mechanisms, and search results may be displayed in a single user interface. A user's interaction with search results and/or feedback provided by a user on search results may be utilized as a data points for future extractions and searches.

The following description refers to the accompanying drawings. Whenever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Referring now to the drawings, in which like numerals represent like elements through the several figures, aspects of the present invention and the exemplary operating environment will be described. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

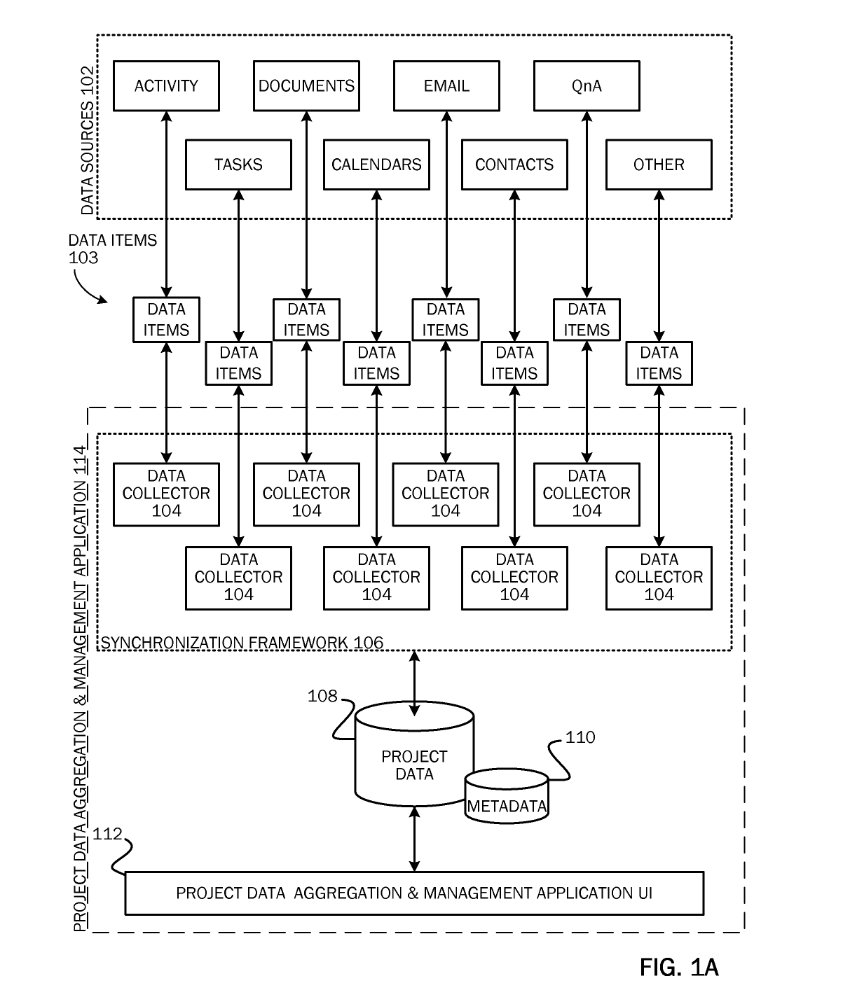

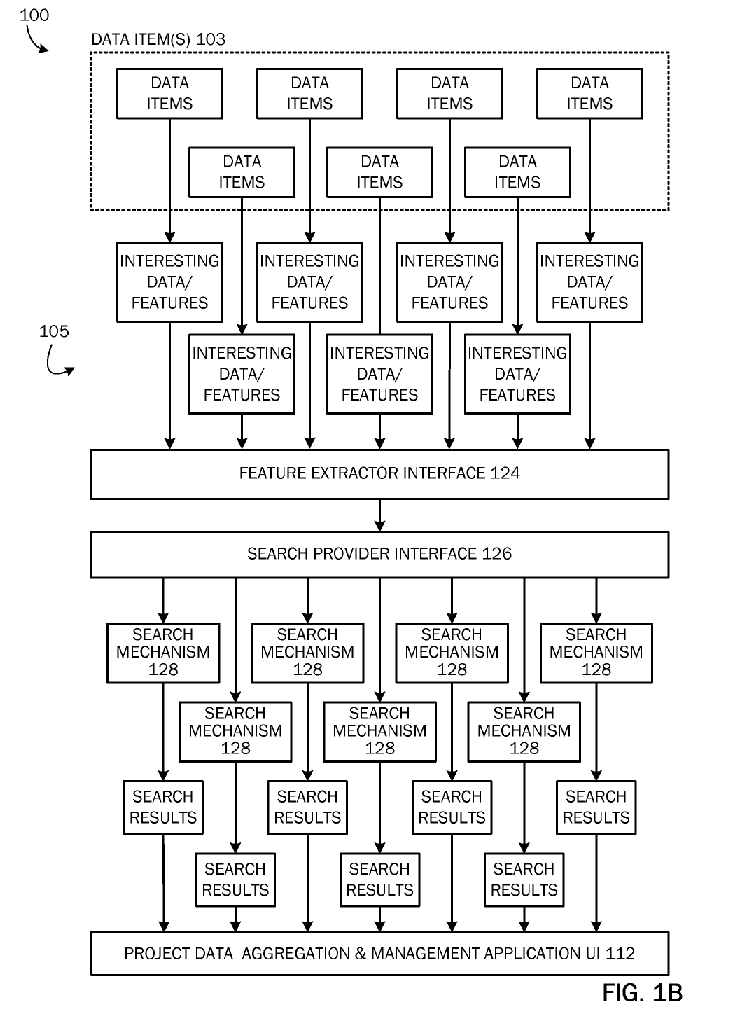

As briefly described above, embodiments are directed to automatically discovering context of a data item, and to bringing together sources of information that may be contextually relevant to the given data item. FIG. 1A lays out a system framework of a project data aggregation and management application (PDAM) application 114, within which embodiments of the present invention may be incorporated.

FIG. 1A is a simplified block diagram of a system architecture for embodiments of a PDAM application 114. Embodiments of a PDAM application may be utilized as a project data aggregation and management tool. Referring now to FIG. 1A, data items 103 may be provided. Data items 103 may be of various content types, and may be from various data sources 102. Data sources 102 may include, but are not limited to, electronic events, electronic activities, electronic documents, electronic mail, electronic questions and answers, electronic task items, electronic calendar items, and electronic contacts items, electronic communications, electronic files or any other electronic data from which data relevant to one or more projects may be retrieved. Data items 103 may include data sources 102 and/or components of data sources 102. For example, a data item 103 may be an electronic mail message or may be a component of an electronic mail message, such as the “subject” line of an electronic mail message. Data items 103 may be located within a local file system, within a web-based content management system, such as SHAREPOINT by MICROSOFT CORPORATION of Redmond, Wash., or located remotely and linked through a communications network. In a distributed computing environment, data items 103 may be located in both local and remote memory storage devices. A data item 103 may be, for example, a calendar item, a contact item, an electronic mail (“email”) communication, a task item, an electronic document (e.g., word processing document, spreadsheet document, slide presentation document, etc.), photographic files, audio files, or any other item of data that may be relevant to one or more projects of interest.

Embodiments of the present invention may comprise a synchronization framework 106, which is a framework of data collection interfaces 104, herein referred to as data collectors. A data collector 104 is an interface that may communicate with a data source 102, and pull data items 103 that may contain relevant information to a project from the data source 102. A project may be created by a user within a PDAM application 114. When a project is created, a title and description may be given to the project, which may be used as metadata 110 for discovering content that may be of relevance to the project. Data collectors 104 may search for content locally and from external repositories. Discovered content may be suggested to a user, wherein the user may accept a suggested piece of content and that data item 103 may be extracted and stored into a project data store 108.

Information that is exchanged between a data source 102 and a data collector 104 may be customizable. For example, if the data source 102 is an electronic mail application, electronic calendar application, electronic task application, or an application that provides combined resources of these applications, for example, OUTLOOK by MICROSOFT CORPORATION of Redmond, Wash., a data collector 104 may be implemented to interface the email application so that it may be operative for discovering data and metadata of an email. As should be appreciated, there may be multiple extraction points of a data source 102. Accordingly, there may be multiple data collectors 104 for a data source 102. Considering the above example, where the data source 102 is an electronic mail application, electronic calendar application, electronic task application, or combination functionality application, one data collector 104 may be implemented to discover email data, and another data collector 104 may be implemented to discover calendar data, and another to discover task data, etc. A data collector 104 may know not only where to get data, but also how and what type of data to retrieve.

As new data sources 102 are added to a project, a synchronization framework 106 may implement new data collector 104 interfaces. For every possible type of collection, an implementation of that interface may be added to the synchronization framework 106. The synchronization framework 106 may pull in data as well as push data back out to a data source 102. Data may be pulled in via one of two modes. According to a first mode, a data source 102 may be checked for new content according to a specified time interval. For example, a data source 102 may be checked every thirty (30) seconds to see if there is new data available. With some data sources 102, it may be inefficient to pull data in such a manner. By utilizing a subscriber-type model, a data source 102 may notify the synchronization framework 106 when a change occurs. Consider, for example, that a data collection, organization and sharing application, for example, SHAREPOINT by MICROSOFT CORPORATION is a data source 102 for a project. The application may use very large lists to transfer data. The list may have thousands of elements, so it would be inefficient to pull them and check a thousand elements every thirty (30) seconds for new data. Accordingly, a second mode may be utilized to check for new data. The synchronization framework 106 may register for an event, wherein the synchronization framework 106 may be notified when a change has occurred.

As data items 103 that are of relevance to a project are pulled from a data source 102 by a data collector, that data may be stored in a project data store 108. The project data store 108 is a data repository or organizational knowledge base, and may be available to and access by others. Data collectors 104 may put data into a project data store 108 in whatever way may be most efficient for the system. For example, if document information is being collected, that data may be put into the data store 108 by downloading the document and associating the whole document with the project. Alternatively, instead of downloading the full document, a link to the document may be downloaded; and, the link information may be tagged with a last modification date. In the same way that various forms of data may be collected from a variety of aggregation points, the way the data is stored internally can vary. Project data 108 may be a collection of identifications to actual data that may be stored locally or in disparate locations. Data may comprise project related content as well as contact information, and any other available content that may be relevant to a project. A project data store 108 may also comprise metadata 110, such as a title, description, other people who may be joined and working on a project, security descriptors, types of content that should be stored within a project, and how it should be displayed in a user interface 112.

According to one embodiment, data may be stored in a data base table, for example a structured query language (SQL) data table. After a project data store 108 is created, all associated content may be added into the data store. The content may consist of a generic wrapper that provides a name, an identifier, a creation date, and other pieces of metadata along with payloads, which consist of the actual data or links to the actual data. For example, if a user adds a contact to a project, a wrapper may be created that may contain a title of the contact, a date it was created, etc., and a payload. For a contact, the payload would be the unique identifier of the user who is being added as a contact. For every type of content within a project, a wrapper and payload exists.

According to an embodiment, a project may coexist with enterprise-level structured projects which may be projects associated with data, data sources and projects spanning organizations and entities of varying sizes and structures. An enterprise project may be a source from which information may be extracted. An enterprise project may comprise deliverables, which may be defined as PDAM application projects. An overall project system may manage these deliverables or PDAM application projects.

A PDAM application user interface (UI) 112 is a modular user interface that may display data items 103 from multiple data sources 102. For example, a PDAM application UI 112 may display data items 103 like calendar data, emails, tasks, etc. as well as any other type of data, such as word processing documents, spreadsheet documents, presentation documents, and social networking correspondences. The PDAM application UI 112 may borrow functionality of one or more applications, such as an electronic mail application, electronic calendar application, electronic task application, or an application that provides combined resources of these applications for displaying and interacting with calendar, task and email items. The PDAM application UI 112 may also extend functionalities of other applications so that it may display other relevant project information.

Within a PDAM application UI 112, a notification system may be provided. According to an embodiment, when a data collector 104 retrieves a data item 103 from a data source 102, a user may be notified through the PDAM application UI 112 that new information is available, so that the user may then act on it. For example, a person in a project may upload a new document relative to the project. Other members in the project may need to know that a new document has been uploaded. The other users may receive a notification that a new activity is available.

According to another embodiment, a user may publish new data through the PDAM application UI 112 that can be sent out to various data sources 102. For example, if a user has a project linked to various communication sources, such as email, instant messaging, and one or more social networks, for example, FACEBOOK or TWITTER, the user may push content back out to one or more of those communication sources. The user may create an email or text message or other suitable messaging form from within the PDAM application UI 112. The PDAM application UI 112 may act as an aggregator of content as well as a way to push content back out to any desired recipient user or recipient system.

Having described a system framework of a project data aggregation and management (PDAM) application 114, within which embodiments of the present invention may be incorporated, FIG. 1B is a simplified block diagram of an operating environment 100 for providing an automatic context discovery of data items 103. As was briefly described above, embodiments of the present invention may look through various data items 103, and search for data that is contextually related to a given project. A data item 103 may be considered related to a project if it contains keywords, questions, answers, terms, links, clip art, authors, senders, receivers, dates, times, as well as, other content from electronic documents, electronic mail, calendar items, contacts items, tasks items, social network communications, or other interesting features which may be associated with the given project. A feature may be associated with a given project if it is contained within a description of the project or if it is contained within other project data or metadata 110 associated with the project. A data item 102 or a feature may also be related to a project if it is considered similar to project data or metadata 110 according to a measurement.

Referring now to FIG. 1B, various data items 103 are shown. A data item 103 may be any data item that may be pulled from a source of information, as described above with reference to FIG. 1A, including, but not limited to, a document (e.g., word processing document, spreadsheet file, etc.), an electronic mail (email) item, a task item, a calendar item, a contact item, a social networking communication, etc. A feature extractor interface 124 may look at various data items 103, and discover features or pieces of data in or associated with the data items 103 that may be considered interesting or important, i.e., contextually relevant to a given project. For example, if a data item 103 is an email, pieces of data that may be selected by the feature extractor interface 124 may include key words from a subject line and body of the email, names and contact information of people to whom the email was sent, name and contact information of the person whom the email was from, whether the email was sent to a distribution list, etc. For any type of data, a set of feature extractors 124 may pull out features or information that may be pertinent to that data item 103 and that may be associated with a project.

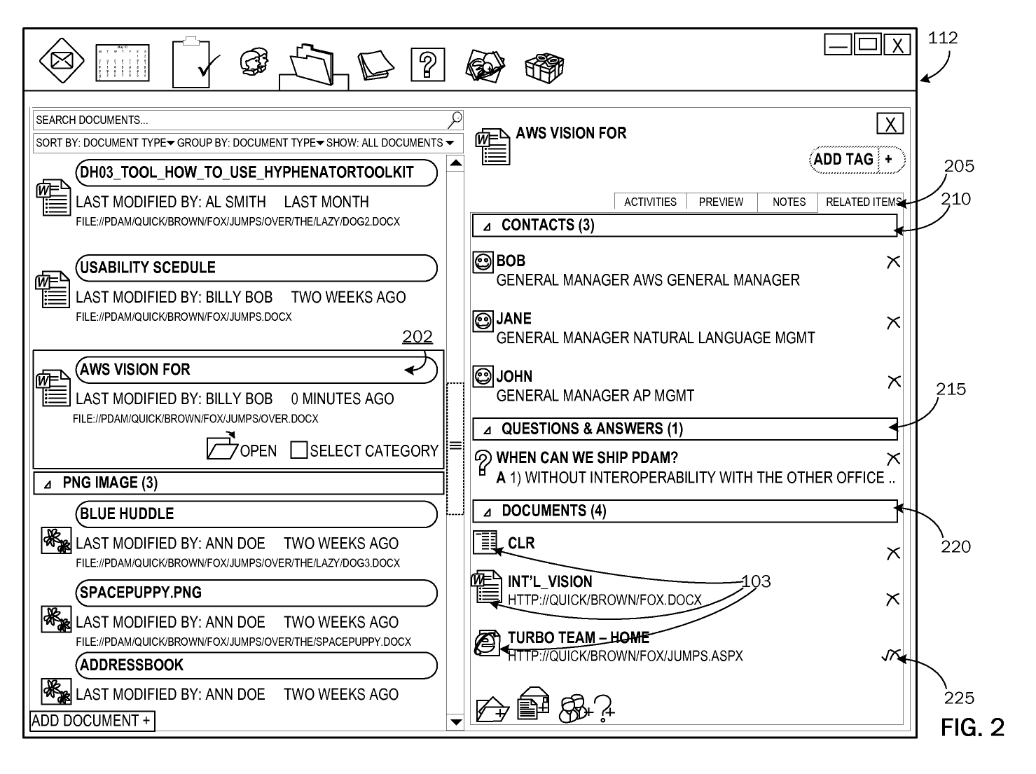

Once features are extracted from a data item 103, those features may be mapped into a unit that can be sent to one or more search mechanisms to find more relevant suggestions for project content by a search provider interface 126. A search may occur locally on a local computer/memory combination, in an email inbox, within a calendar, on the Internet, within a web-based content management system, such as SHAREPOINT by MICROSOFT CORPORATION of Redmond, Wash., etc. A search mechanism 128 may be selected depending on a particular type of content. For example, if a search is for a document, a search query may be sent to a desktop search or a web-based content management system search. If a search is for an email or calendar item, a search query may be sent to an email application search. According to an embodiment, information about a user, such as information from a user's contacts list, email, task list, Internet browsing history, presence data, location, calendar items, and the like, may be used to improve search results. Search results from all search mechanisms 128 may be displayed within a single user interface 112, and presented to a user, as is shown in FIG. 2.

With reference to FIG. 2, an example PDAM application UI 112 is shown. Within the UI 112, data items 103 which have been discovered as relevant to a selected document within a project may be displayed under a “Related Items” tab 205. As described above, a data item 103 may be considered relevant to a project if features or pieces of data contained within that data item match features extracted from project data items and metadata 210 within a project data store 208 of a given project. Features may be pieces of data that may be considered interesting or important. As shown, contacts 210, question and answers 215, documents 220, etc. may be extracted from various data sources 102. A suggested feature may be accepted or declined by a user via a selectable accept or decline icon 225. Search results from all search mechanisms 128 may be displayed within a single user interface 112, and presented to a user, as shown in FIG. 2.

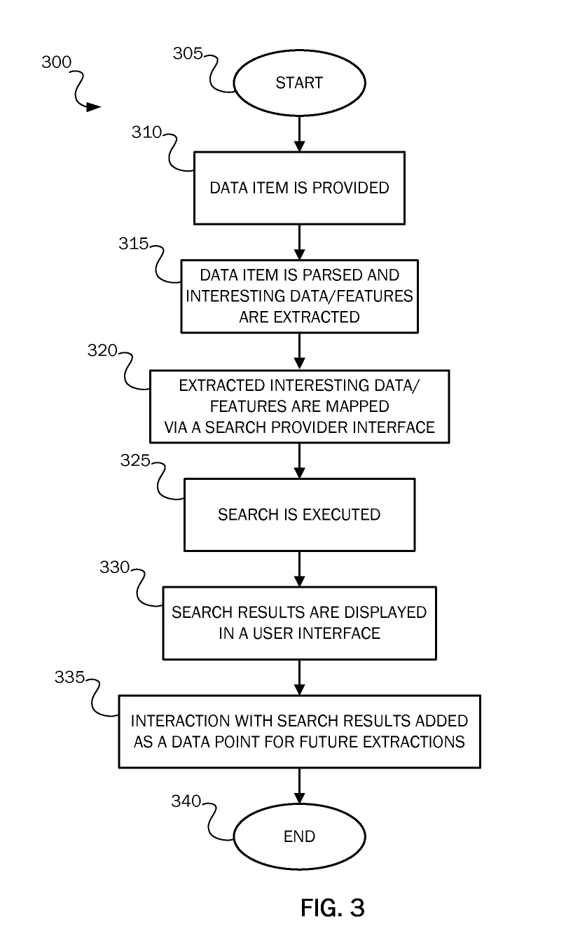

Referring now to FIG. 3, a process flow diagram of a method 300 for automatically bringing together sources of information that may be relevant to a given data item is shown. The method starts at OPERATION 305, and proceeds to OPERATION 310, where a data item 103 is provided. As described above, the data item 103 may be from any type of data source 102, including, but not limited to, a document (e.g., word processing document, spreadsheet file, presentation document, project file, etc.), an email, a task item, a calendar item, a contact item, a social networking communication, etc.

The method proceeds to OPERATION 315, where the data item 103 is parsed for contextual information for the data item, including data item features 105, for example, keywords, questions, answers, terms, links, clip art, authors, senders, receivers, dates, times, as well as, other content from electronic documents, electronic mail, calendar items, contacts items, tasks items, social network communications and the like that may be pertinent or contextually relevant to a given project. A feature extractor interface 124 may be utilized to extract select pieces of data. For example, if the data item 103 is a document, the feature extractor interface 124 may select key words, links within the document, clip art, author(s) of the document, etc.

The method proceeds to OPERATION 320, where the selected and extracted data item features may be mapped into a unit that can be sent to various search mechanisms via a search provider interface 126. At OPERATION 325, a federated search scheme may be utilized, wherein multiple search systems may be called on to find other relevant content as was described above with reference to FIGS. 1A and 1B. The search may be a local desktop search, a search of a local computer/memory, a search of a remote server-based computer/memory combination, a web-based content-management system search, an Internet search, etc.

The method proceeds to OPERATION 330, where results may be displayed within a user interface 112, as illustrated in FIG. 2. According to embodiments, all search results may be returned in a single location programmatically. At OPERATION 335, information from the search results may be used as feedback to modify the initial feature list. Through a mechanism, which may be automatic or manual, a search result may be determined as relevant or not relevant. The initial feature extractors or search mechanism(s) may be modified based on the feedback, so that future extractions and searches may return more relevant results. That is, a feedback loop may be provided, allowing a user to accept or interact with a search result item, wherein that interaction may be utilized as a data point for subsequent or future searches and extractions. That is, the data point for future searches may be in the form of teaching of the search mechanism. For example, if the user always accepts “Subject” line data extracted form emails, but always rejects “To” line data extracted from emails, the search mechanism may determine that “To” line data should not be extracted and suggested to the user in future searches. A user may manually select that a search result is relevant or not relevant. Alternatively, a user's interaction with a search result may be utilized to determine whether the search result is relevant or not relevant. According to an embodiment, interaction data from other users who are associated with data items and/or within a project may be utilized as data points for future searches. A user's interaction with search results may affect future searches for other users who may be interacting with an associated project. Whether users find a search result as relevant or not may be utilized in a determination as to what data items may be returned as future suggested items.

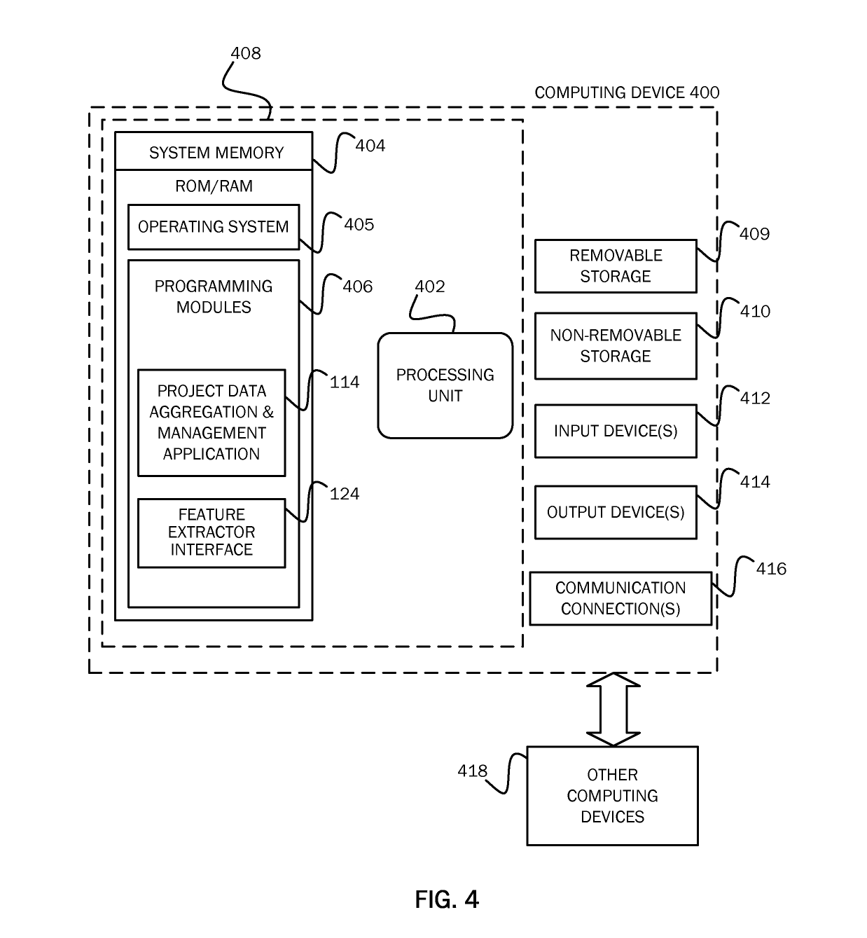

As described above, embodiments of the invention may be implemented via local and remote computing and data storage systems, including the systems illustrated and described with reference to FIGS. 1A and 1B. Consistent with embodiments of the invention, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any other computing devices 418, in combination with computing device 400, wherein functionality may be brought together over a network in a distributed computing environment, for example, an intranet or the Internet, to perform the functions as described herein. The aforementioned system, device, and processors are examples and other systems, devices, and processors may comprise the aforementioned memory storage and processing unit, consistent with embodiments of the invention. Furthermore, computing device 400 may comprise operating environment 100 as described above. Operating environment 100 is not limited to computing device 400.

With reference to FIG. 4, a system consistent with embodiments of the invention may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include project data aggregation and management application 407 and filtering module 122, wherein project data aggregation and management application 407 and filtering module 122 are software applications having sufficient computer-executable instructions, which when executed, performs functionalities as described herein. Operating system 405, for example, may be suitable for controlling computing device 400's operation. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computing device 400 may also contain a communication connection 416 that may allow device 400 to communicate with other computing devices 418, such as over a network in a distributed computing environment, for example, an intranet or the Internet. Communication connection 416 is one example of communication media.

As stated above, a number of program modules and data files may be stored in system memory 404, including operating system 405. While executing on processing unit 402, programming modules 406 and may include the project data aggregation and management application 114 and feature extractor interface 124, wherein project data aggregation and management application 114 and feature extractor interface 124 may contain sufficient computer-executable instructions, which when executed, perform functionalities as described herein. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The term computer readable media as used herein may include computer storage media. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

We claim:

1. A method for providing an automatic discovery of a context of a data item, the method comprising:
parsing a first data item for one or more data item features;
extracting the one or more data item features from the first data item;
mapping the extracted one or more data item features to one or more of search mechanisms;
searching for one or more other data items related to the first data item, wherein the one or more data items are associated with the one or more data item features; and
displaying search results from the one or more search mechanisms in a user interface.

2. The method of claim 1, wherein mapping the extracted one or more data item features to one or more of search mechanisms includes mapping the extracted one or more data item features to one or more of search mechanisms via a search provider interface.

3. The method of claim 1, wherein parsing a first data item for one or more data item features includes parsing one of an electronic event, an electronic activity, an electronic document, an electronic mail item, an electronic question, an electronic answer, an electronic task item, an electronic calendar item, and an electronic contacts item, an electronic communication, an electronic file and an electronic data.

4. The method of claim 1, wherein parsing a first data item for one or more data item features includes parsing the first data item for one or more of a keyword, a question, an answer, a term, a link, a clip art item, an author, a sender, a receiver, a date, a time, an electronic event component, an electronic activity component, an electronic mail component, an electronic calendar item component, an electronic contacts item component, an electronic task item component, an electronic communication component, an electronic document component, an electronic file component, and an electronic data component.

5. The method of claim 1, wherein displaying search results from the one or more search mechanisms in a user interface includes displaying the one or more data items associated with the one or more data item features.

6. The method of claim 5, wherein the search results include one or more data item types.

7. The method of claim 1, further comprising utilizing user interaction data associated with search results as a data point for future extractions.

8. The method of claim 1, further comprising utilizing user interaction data associated with search results as a data point for searches.

9. The method of claim 1, prior to mapping the extracted one or more data item features to one or more of search mechanisms, selecting the one or more search mechanisms based on a type of data that is extracted.

10. The method of claim 1, wherein searching for one or more other data items related to the first data item includes searching for one or more other data items related to the first data item via a local data storage.

11. The method of claim 1, wherein searching for one or more other data items related to the first data item includes searching for one or more other data items related to the first data item via a remote data storage.

12. A computer-readable medium which stores a set of instructions which when executed performs a method for providing an automatic discovery of a context of a data item, the method executed by the set of instructions comprising:
parsing a data item for contextual information for the data item;
extracting the contextual information from the data item;
mapping extracted contextual information for the data item to a plurality of search mechanisms;
searching for one or more other data items related to the extracted contextual information for the data item; and
displaying search results from the plurality of search mechanisms in a single user interface.

13. The computer-readable medium of claim 12, wherein mapping extracted contextual information for the data item to a plurality of search mechanisms includes mapping the extracted contextual information for the data item to a plurality of search mechanisms via a search provider interface.

14. The computer-readable medium of claim 13, wherein parsing a data item for contextual information for the data item includes parsing one of an electronic event, an electronic activity, an electronic document, an electronic mail item, an electronic question, an electronic answer, an electronic task item, an electronic calendar item, and an electronic contacts item, an electronic communication, an electronic file and an electronic data.

15. The computer-readable medium of claim 14, wherein parsing a data item for contextual information for the data item includes parsing a data item for one or more of a keyword, a question, an answer, a term, a link, a clip art item, an author, a sender, a receiver, a date, a time, an electronic event component, an electronic activity component, an electronic mail component, an electronic calendar item component, an electronic contacts item component, an electronic task item component, an electronic communication component, an electronic document component, an electronic file component, and an electronic data component.

16. The computer-readable medium of claim 12, further comprising utilizing user interaction data associated with search results to modify subsequent extractions.

17. The computer-readable medium of claim 12, further comprising utilizing user interaction data associated with search results to modify subsequent searches.

18. The computer-readable medium of claim 12, prior to mapping extracted contextual information for the data item to a plurality of search mechanisms, selecting the one or more search mechanisms based on a type of contextual information that is extracted.

19. The computer-readable medium of claim 12, wherein displaying search results from the plurality of search mechanisms in a single user interface includes displaying the one or more other data items related to the extracted contextual information for the data item.

20. A system for providing an automatic discovery of context of a data item, the system comprising:
a memory storage;
a processing unit coupled to the memory storage, wherein the processing unit is operative to run:
a feature extractor interface operative to parse a first data item for one or more data item features and to extract the one or more data item features from the first data item;
a search provider interface operative to map the extracted one or more data item features to one or more of search mechanisms;
a plurality of search mechanisms operative to search for one or more other data items related to the first data item, wherein the one or more data items are associated with the one or more data item features; and
an application user interface operative to display search results from the one or more search mechanisms in a user interface.
